(19) United States
(12) Patent Application Publication
(10) Pub. No.: US 2025/0246797 A1
(43) Pub. Date: Jul. 31, 2025

(54) ANTENNA DEVICE AND IC CARD

(71) Applicant: TDK Corporation, Tokyo (JP)

(72) Inventor: Shoma KAJIKIYA, Chuo-ku, Tokyo (JP)

(73) Assignee: TDK Corporation, Tokyo (JP)

(21) Appl. No.: 19/038,736

(22) Filed: Jan. 28, 2025

(30) Foreign Application Priority Data
Jan. 30, 2024 (JP) 2024-011647

(51) Int. Cl. H01Q 1/22; H01Q 1/52; H01Q 7/00

(52) U.S. Cl. CPC H01Q 1/2283; H01Q 1/526; H01Q 7/00

(57) ABSTRACT

An antenna device includes a resin layer having a first trench extending in a first direction and a second direction intersecting the first direction, and a conductor pattern including a plurality of first electroconductive lines extending in the first direction and a plurality of second electroconductive lines extending in the second direction, and including a plurality of first mesh portions, in which the conductor pattern includes a first region and a second region in which the first mesh portion is not formed, the second region extends from the first region to an edge of the conductor pattern, a width of the second region is smaller than a width of the first region, the first region has a through hole penetrating from one end to another end in a thickness direction of the resin layer, and the resin layer is disposed in the second region.

### CROSS-REFERENCE TO RELATED APPLICATION

This application is based upon and claims the benefit of priority from Japanese Patent Application No. 2024-011647, filed on Jan. 30, 2024, the entire contents of which are incorporated herein by reference.

### TECHNICAL FIELD

The present disclosure relates to an antenna device and an IC card.

### BACKGROUND

Conventionally, an antenna device including a mesh-shaped conductor pattern is known (for example, Japanese Unexamined Patent Publication No. 2014-7655). In this antenna device, a notch is formed at a position where the IC chip is disposed.

### SUMMARY

An antenna device according to one aspect of the present disclosure includes a resin layer having a first trench extending in a first direction and a second direction intersecting the first direction, and a conductor pattern disposed in the first trench of the resin layer, including a plurality of first electroconductive lines extending in the first direction and a plurality of second electroconductive lines extending in the second direction, and including a plurality of first mesh portions, in which the conductor pattern includes a first region and a second region in which the first mesh portion is not formed, the second region extends from the first region to an edge of the conductor pattern, a width of the second region is smaller than a width of the first region, the first region has a through hole penetrating from one end to another end in a thickness direction of the resin layer, and the resin layer is disposed in the second region.

An IC card according to one aspect of the present disclosure includes a card main body including a first card base material and a second card base material, the antenna device described above disposed between the first card base material and the second card base material, and an IC module disposed in an IC mounting opening of the first card base material.

### BRIEF DESCRIPTION OF THE DRAWINGS

FIG. 1 is a schematic perspective view illustrating an appearance of an IC card incorporating an antenna device according to an embodiment of the present disclosure;

FIG. 2 is an exploded perspective view of the IC card as viewed from a lower surface side;

FIG. 3 is a cross-sectional view taken along line III-III illustrated in FIG. 1;

FIG. 4 is a plan view of the antenna device;

FIGS. 5A, 5B, and 5C are cross-sectional views of the antenna device;

FIG. 6 is a developed cross-sectional view illustrating an IC card according to a modification;

FIG. 7 is a developed cross-sectional view illustrating an IC card according to a modification;

FIG. 8 is a developed cross-sectional view illustrating an IC card according to a modification;

FIG. 9 is a cross-sectional view illustrating an IC card according to a modification;

FIG. 10 is a view for explaining dimensions of electroconductive lines;

FIG. 11 is an enlarged view of the vicinity of a connection portion between a slit and an opening;

FIG. 12 is an enlarged view of the vicinity of a connection portion between a slit and an opening;

FIG. 13 is an enlarged view of the vicinity of an outer peripheral surface of a protective layer;

FIG. 14 is a plan view of the antenna device;

FIG. 15A is a cross-sectional view taken along line XVa-XVa illustrated in FIG. 11, and FIG. 15B is a cross-sectional view taken along line XVb-XVb illustrated in FIG. 11;

FIG. 16 is a plan view of an antenna device according to a modification; and

FIG. 17 is a cross-sectional view of the vicinity of a gap.

### DETAILED DESCRIPTION

Here, in the antenna device as described above, the notched portion is a penetrating portion penetrating the sheet. In this case, there is a problem that, when mesh patterns come into contact with each other due to deformation of the notched portion and a loop is formed, the antenna device does not function as an antenna. Further, it has been required to reduce the thickness of the antenna device.

Thus, an object of the present disclosure is to provide an antenna device and an IC card capable of achieving thickness reduction while suppressing contact between mesh-shaped conductor patterns.

According to one aspect of the present disclosure, it is possible to provide an antenna device and an IC card capable of achieving thickness reduction while suppressing contact between mesh-shaped conductor patterns.

Hereinafter, some embodiments of the present disclosure will be described in detail. However, the present disclosure is not limited to the following embodiments.

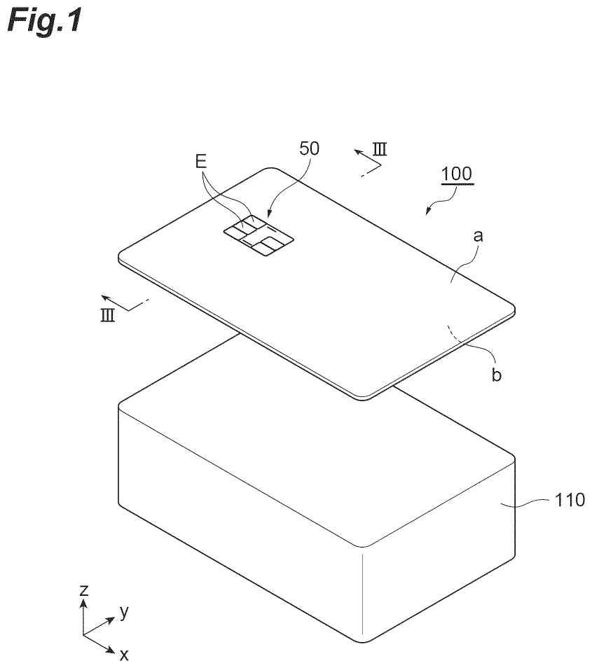

FIG. 1 is a schematic perspective view illustrating an appearance of an IC card 100 incorporating an antenna device according to an embodiment of the present disclosure. The IC card 100 illustrated in FIG. 1 is a plate-shaped body in which a y-axis direction is a lateral direction, an x-axis direction is a longitudinal direction, and a z-axis direction is a thickness direction, and has an upper surface a and a lower surface b constituting an xy surface. The IC card 100 incorporates an IC module 50 and an antenna device to be described later, and a terminal electrode E of the IC module is exposed on the upper surface a of the IC card 100. The IC card 100 can perform communication via the antenna device by being brought close to the card reader 110. Note that an application example of the IC card 100 is not particularly limited, but the IC card may be applied to a transparent IC card capable of non-contact communication in which a wire or a conductor pattern of a conductive line forming the antenna cannot be visually recognized, and may be, for example, a transparent dual interface card such as a bank card or a credit card.

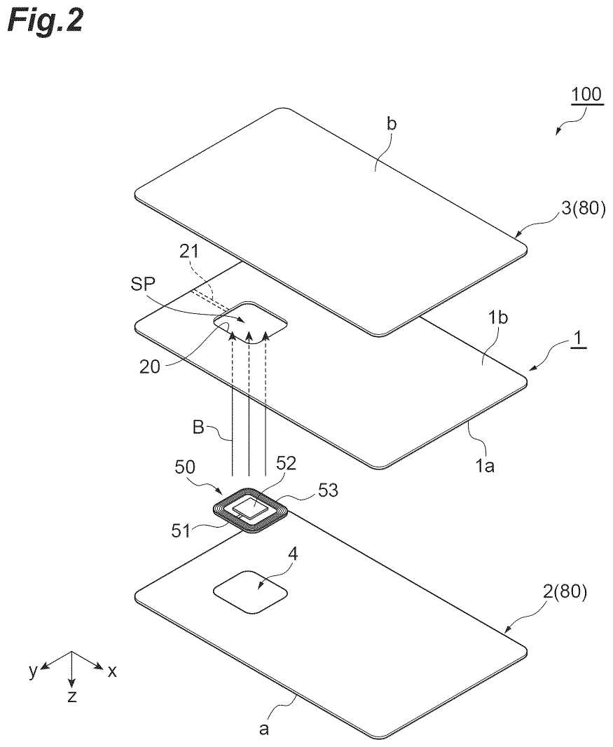

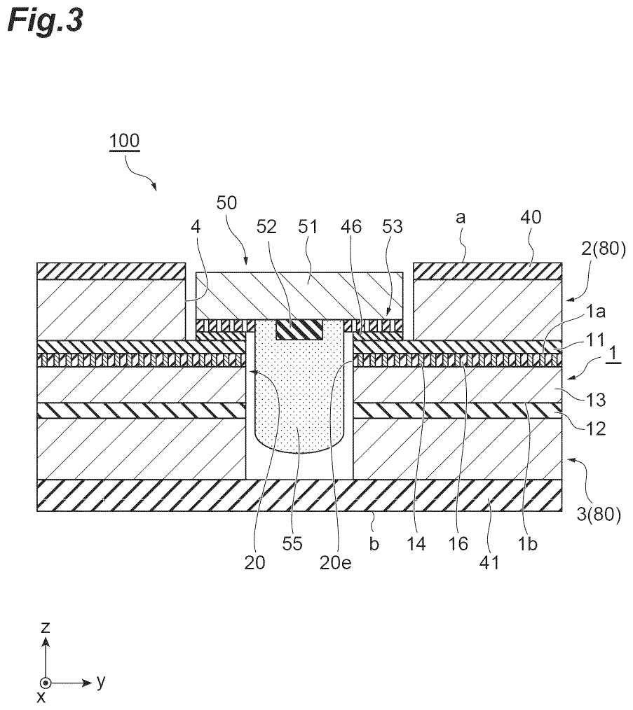

FIG. 2 is an exploded perspective view of the IC card 100 as viewed from the lower surface b side. FIG. 3 is a cross-sectional view taken along line III-III illustrated in FIG. 1. FIG. 3 illustrates a structure near the IC module 50. As illustrated in FIGS. 2 and 3, the IC card 100 includes a card main body 80, an antenna device 1, and the IC module 50. The card main body 80 includes a first card base material 2 and a second card base material 3. The IC card 100 has a structure in which the first card base material 2, the antenna device 1, and the second card base material 3 are stacked in this order from the upper surface a side toward the lower surface b side. Further, the IC card 100 includes the IC module 50. Note that, in the present embodiment, the IC module 50 is disposed in a region of the IC card 100 on a negative side in the X-axis direction and at a position closer to a positive side in the Y-axis direction. However, the position of the IC module 50 is not particularly limited. Note that, in the example illustrated in FIG. 3, an electroconductive line of a conductor pattern 14 of the antenna device 1 is exposed from an inner peripheral surface of a through hole and an outer peripheral surface of a resin layer 16 (details will be described later).

The first card base material 2 is a plate-shaped member that covers the main surface 1a on the positive side in the z-axis direction of the antenna device 1. The printing layer 40 provided on the surface of the first card base material 2 on the positive side in the z-axis direction constitutes the upper surface a of the IC card 100. The first card base material 2 is provided with an IC mounting opening 4 having a substantially rectangular shape. The IC mounting opening 4 penetrates the first card base material 2 in the thickness direction (Z-axis direction). The IC module 50 is disposed inside the IC mounting opening 4 (see FIG. 3). The second card base material 3 is a plate-shaped member that covers the main surface 1b on the negative side in the z-axis direction of the antenna device 1. The printing layer 41 provided on the surface of the second card base material 3 on the negative side in the z-axis direction constitutes the lower surface b of the IC card 100. The first card base material 2 is bonded to the antenna device 1 via an adhesive layer 11. The second card base material 3 is bonded to the antenna device 1 via an adhesive layer 12.

The card base materials 2 and 3 may be transparent resin substrates. The card base materials 2 and 3 may be formed by, for example, cellulose propionate (CP), polyvinyl chloride (PVD), polycarbonate (PC), tempered glass, or the like. The thicknesses of the card base materials 2 and 3 are not particularly limited, but may be 100 to 500 μm. The total light transmittance of the card base materials 2 and 3 may be 90 to 100%. In the embodiment illustrated in FIG. 3, the first card base material 2 is formed to have a thickness larger than a thickness of the second card base material 3.

As the adhesive layers 11 and 12, an adhesive sheet of a thermoplastic resin or a thermosetting resin having high transparency may be employed. As the material of the adhesive sheet, acrylic, urethane-based, epoxy-based, or phenol-based materials may be employed. The adhesive layers 11 and 12 may have no base material, high total light transmittance, and low haze. The thicknesses of the adhesive layers 11 and 12 are not particularly limited, but may be 10 to 100 μm. The total light transmittance of the adhesive layers 11 and 12 may be 90 to 100%.

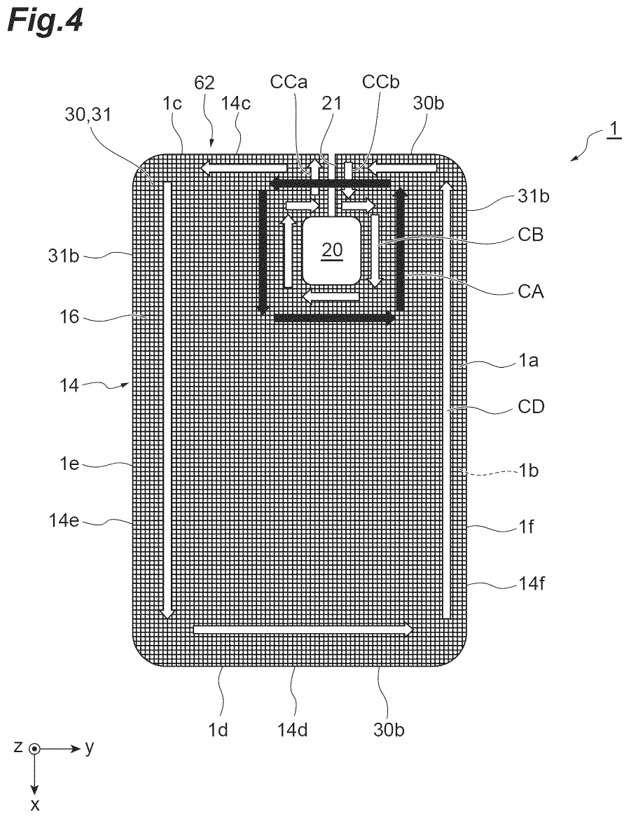

FIG. 4 is a plan view of the antenna device 1. As illustrated in FIG. 4, the antenna device 1 is a rectangular plate-shaped member. The antenna device 1 includes a negative-side edge 1c in the x-axis direction, a positive-side edge 1d in the x-axis direction, a negative-side edge 1e in the y-axis direction, and a positive-side edge 1f in the y-axis direction. In the present embodiment, the edges 1c and 1d are short sides, and the edges 1e and 1f are long sides.

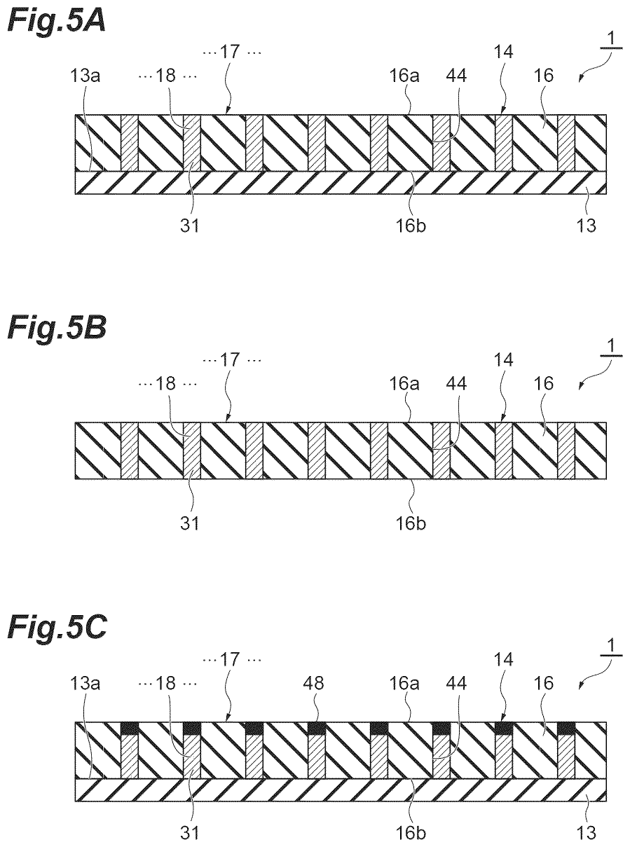

The antenna device 1 includes the mesh-shaped conductor pattern 14 having a plurality of first mesh portions 17 (see FIGS. 5A to 5C), and the resin layer 16 that supports the conductor pattern 14. The conductor pattern 14 is a mesh-shaped pattern including a plurality of regularly arranged first mesh portions 17 (see FIGS. 5A to 5C) formed by a plurality of electroconductive lines intersecting each other. Note that details of the configuration of the pattern of the conductor pattern 14 will be described later. The conductor pattern 14 is formed on substantially the entire surface of the main surface 1a of the antenna device 1. The conductor pattern 14 has a rectangular shape corresponding to the shape of the main surface 1a. The conductor pattern 14 includes an edge 14c on the negative side in the x-axis direction, an edge 14d on the positive side in the x-axis direction, an edge 14e on the negative side in the y-axis direction, and an edge 14f on the positive side in the y-axis direction.

In the conductor pattern 14, an opening 20 (first region) and a slit 21 (second region) extending from the opening 20 to an edge 14c of the conductor pattern 14 are formed as a region where the first mesh portion 17 and the electroconductive line (first electroconductive line and second electroconductive line to be described later) are not formed. The opening 20 is configured as a penetrating portion that penetrates the antenna device 1 from the main surface 1a to the main surface 1b. The opening 20 is formed at a position where the IC module 50 is disposed. The opening 20 has a rectangular shape corresponding to the shape of the IC module 50. The slit 21 extends from the opening 20 to the edge 14c. The slit 21 extends from the side on the negative side in the x-axis direction of the opening 20 to the edge 14c on the negative side in the x-axis direction of the conductor pattern 14. The slit 21 extends parallel to the x-axis direction with a constant width. Note that the width of the slit 21 and the width of the opening 20 are dimensions in a direction orthogonal to an extending direction of the slit 21 and the penetrating direction of the opening 20, that is, a distance between edges extending along the extending direction of the slit 21. The width (dimension in the y-axis direction) of the slit 21 is smaller than the width (dimension in the y-axis direction) of the opening 20.

As illustrated in FIG. 5A, the antenna device 1 includes a base material 13, the conductor pattern 14 provided on one first main surface 13a of the base material 13, and the resin layer 16 provided on the first main surface 13a of the base material 13. The resin layer 16 includes a first trench 44 extending in a direction along the first main surface 13a of the base material 13. The first trench 44 has a groove structure formed in the resin layer 16, and extends from one end 16a to the other end 16b in the thickness direction of the resin layer 16. The conductor pattern 14 extends in a direction along the first main surface 13a of the base material 13 and has a plurality of first mesh portions 17. Each electroconductive line of the conductor pattern 14 is disposed in the first trench 44 of the resin layer 16. The conductor pattern 14 has conductor portions 18 forming the first mesh portion 17. The resin layer 16 is disposed between a plurality of conductor portions 18, that is, in the first mesh portions 17. Thus, the plurality of conductor portions 18 has a structure supported by the resin layer 16. In FIGS. 5A to 5C, the conductor portions 18 are illustrated in a deformed state, and the width and pitch of the conductor portions 18 are adjusted.

The base material 13 has light transmissivity to an extent required as the antenna device 1. The total light transmittance of the antenna device 1 in which the conductor pattern 14 having the plurality of first mesh portions 17 and the resin layer 16 are provided on the base material 13 may be 80% or more, and specifically, the total light transmittance of the base material 13 may be 90 to 100%. The haze of the base material 13 may be 0 to 5%.

The base material 13 may be, for example, a transparent resin film, and examples thereof include a film of polyethylene terephthalate (PET), polycarbonate (PC), polyethylene naphthalate (PEN), cycloolefin polymer (COP), or polyimide (PI). Alternatively, the base material 13 may be a glass substrate.

The thickness of the base material 13 may be equal to or more than 10 μm, equal to or more than 20 μm, or equal to or more than 35 μm, and may be equal to or less than 500 μm, equal to or less than 200 μm, or equal to or less than 100 μm.

The conductor portion 18 may contain metal. The conductor portion 18 may contain at least one metal selected from copper, nickel, cobalt, palladium, silver, gold, platinum, and tin, or may contain copper. The conductor portion 18 may be metal plating formed by a plating method. The conductor portion 18 may be a metal layer formed by printing and coating a metal paste. The conductor portion 18 may further contain a nonmetallic element such as phosphorus within a range in which appropriate conductivity is maintained.

The resin layer 16 is formed by a light-transmissive resin and is provided so as to fill the first mesh portions 17, and a flat surface is usually formed by the resin layer 16 and the conductor portion 18.

The resin layer 16 is formed by a light-transmissive resin. The total light transmittance of the resin layer 16 may be 90 to 100%. The resin layer 16 may have a haze of 0 to 5%.

The resin that forms the resin layer 16 may be a cured product of a curable resin composition (photocurable resin composition or thermosetting resin composition). The curable resin composition forming the resin layer 16 includes a curable resin, and examples thereof include an acrylic resin, an amino resin, a cyanate resin, an isocyanate resin, a polyimide resin, an epoxy resin, an oxetane resin, a polyester, an allyl resin, a phenolic resin, a benzoxazine resin, a xylene resin, a ketone resin, a furan resin, a COPNA resin, a silicon resin, a dicyclopentadiene resin, a benzocyclobutene resin, an episulfide resin, a thiol-ene resin, a polyazomethine resin, a polyvinyl benzyl ether compound, acenaphthylene, and an ultraviolet curable resin containing a functional group that causes a polymerization reaction with ultraviolet rays such as an unsaturated double bond, a cyclic ether, and a vinyl ether.

As illustrated in FIG. 3, a through hole penetrating the resin layer 16 and the base material 13 in the z-axis direction is formed in the opening 20. Therefore, the opening 20 is a region where the resin layer 16, the base material 13, and the conductor pattern 14 do not exist. In the antenna device 1 before being assembled as the IC card 100, a space SP is provided in the opening 20 (see FIG. 2). In the antenna device 1 assembled as the IC card 100, a module including an IC chip 52 is arranged in the space SP of the opening 20. Note that, in the space SP, the periphery of the IC chip 52 is covered with a protective resin 55.

The conductor pattern 14 and the resin layer 16 are disposed on the second card base material 3 via the adhesive layer 12. In the example illustrated in FIG. 3, the conductor pattern 14 and the resin layer 16 are disposed on the base material 13. In the IC card 100, the base material 13 is disposed on the negative side in the z-axis direction, and the conductor pattern 14 and the resin layer 16 are disposed on the positive side in the z-axis direction. Therefore, the second card base material 3, the base material 13, the conductor pattern 14, and the first card base material 2 are stacked in this order from the negative side to the positive side in the z-axis direction.

The IC module 50 includes a module substrate and an IC chip 52 mounted on or incorporated in a module substrate 51, and a coupling coil 53 is formed on a negative surface of the module substrate 51 in the z-axis direction (see also FIG. 2). The terminal electrode E illustrated in FIG. 1 is provided on the front surface side of the module substrate 51.

The IC module 50 is disposed in the IC mounting opening 4 of the first card base material 2. The inner peripheral surface of the IC mounting opening 4 is disposed so as to surround the IC module 50 from the outer peripheral side. The IC module 50 is disposed to face the opening 20 of the antenna device 1 at a position on the positive side in the z-axis direction. The sizes of the opening 20 in the y-axis direction and the x-axis direction are smaller than those of the IC module 50. Further, the sizes of the opening 20 in the y-axis direction and the x-axis direction are smaller than an edge on an outer peripheral side of the coupling coil 53 and larger than an edge on an inner peripheral side of the coupling coil 53. Thus, when viewed from the z-axis direction, four inner peripheral surfaces 20e of the opening 20 are disposed so as to overlap four side portions of the coupling coil 53. Note that the first card base material 2 is opened larger than the antenna device 1 and the like. The coupling coil 53 is joined to the stepped portion of the antenna device 1 via the hot melt tape 46 and the adhesive layer 11.

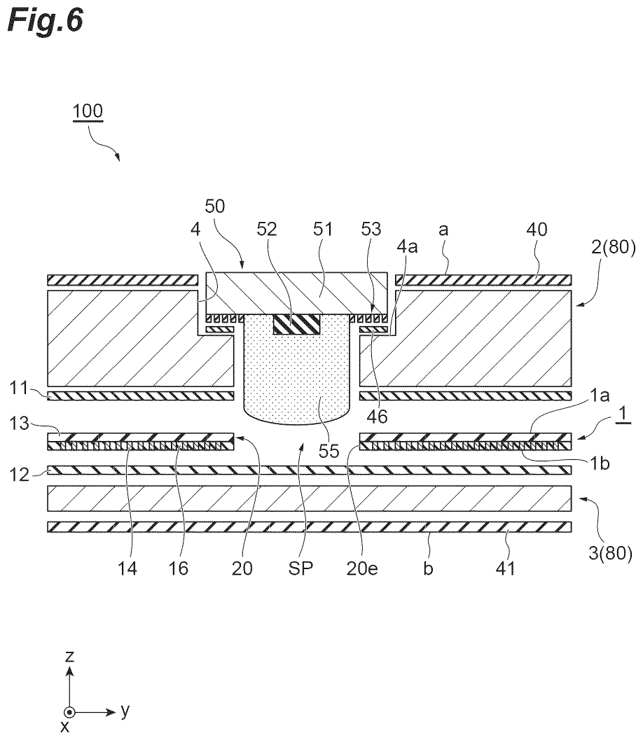

Note that the IC card 100 is not limited to the structure illustrated in FIG. 3, and the structures illustrated in FIGS. 6 to 9 may be employed. Note that FIGS. 6 to 8 illustrate developed views of the respective members developed in the stacking direction (Z-axis direction). In the IC card 100 illustrated in FIG. 6, the conductor pattern 14 is disposed on the second card base material 3 side (the negative side in the Z-axis direction), and the base material 13 is disposed on the first card base material 2 side (the positive side in the Z-axis direction). Further, the IC mounting opening 4 of the first card base material 2 includes a stepped portion 4a facing the coupling coil 53 on the negative side in the z-axis direction. The coupling coil 53 is joined to the stepped portion 4a via the hot melt tape 46. The conductor pattern 14 is not exposed from the inner peripheral surface and the outer peripheral surface of the resin layer 16, and is separated from the inner peripheral surface and the outer peripheral surface (specific configuration will be described later).

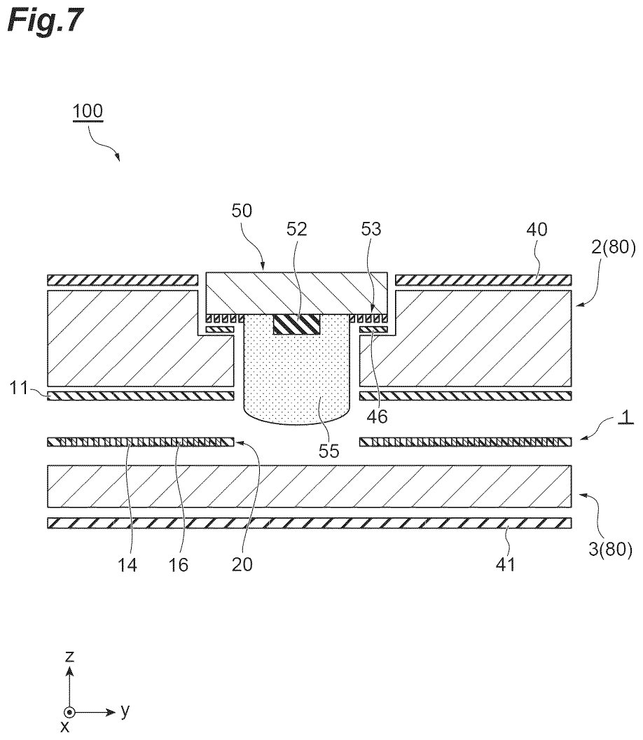

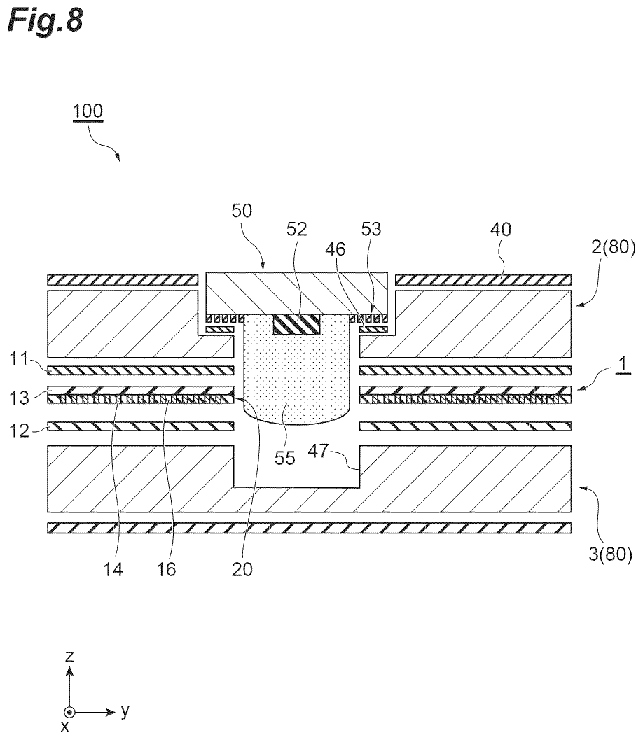

In the IC card 100 illustrated in FIG. 7, the base material 13 of the antenna device 1 is omitted. Thus, in the antenna device 1, as illustrated in FIG. 5B, the resin layer 16 and the conductor pattern 14 are not supported by the base material 13 and exist as a single sheet. In the configuration illustrated in FIG. 7, since the conductor pattern 14 and the resin layer 16 are directly formed on the second card base material 3, the adhesive layer 12 is also omitted in addition to the base material 13. In addition, the thickness of the second card base material 3 may be increased by the omission of these layers. In the IC card 100 illustrated in FIG. 8, the thickness of the second card base material 3 is increased to provide the groove portion 47 as compared with the configuration illustrated in FIG. 6. The groove portion 47 is provided at a position corresponding to the opening 20. The groove portion 47 can be used as a space for accommodating the IC chip 52 and the protective resin 55. The thickness of the second card base material 3 at this time may be about the same as the thickness of the first card base material 2.

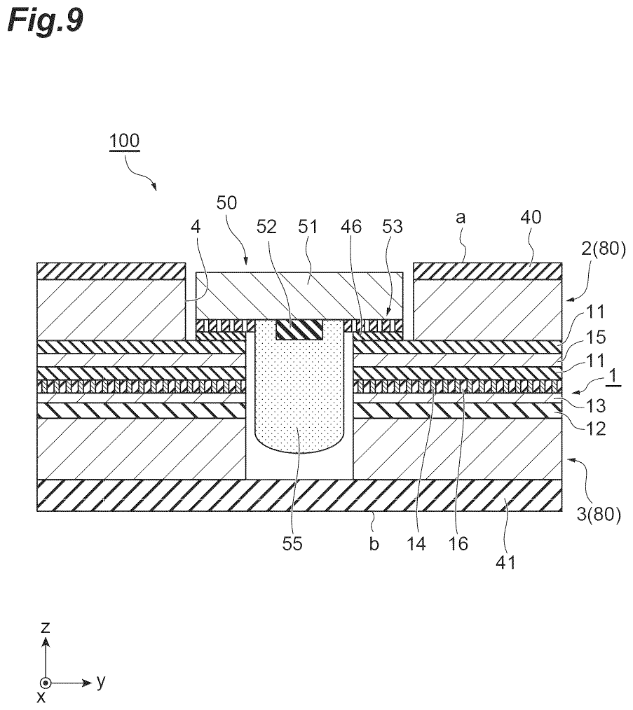

The IC card 100 illustrated in FIG. 9 is obtained by adding an infrared ray shielding layer 15 to the IC card 100 illustrated in FIG. 3. The infrared ray shielding layer 15 that shields infrared rays is disposed between the first card base material 2 and the second card base material 3. Accordingly, the base material 13 becomes thinner. The infrared ray shielding layer 15 is disposed between the first card member 2 and the antenna device 1 via the adhesive layer 11. The infrared ray shielding layer 15 may be formed by a sheet-like film, or may be formed by printing and applying a paste. The infrared ray shielding layer 15 only needs to be formed by a material that does not transmit infrared rays, and in a case where the IC card 100 is applied to a card that detects the presence of the card by attenuation of light, a light transmission density larger than 1.1 in the light wavelength range of 950 nm to 1000 nm is required, and thus it is only required that the infrared ray shielding layer is formed by a material that does not transmit infrared rays while satisfying this light transmission density. Note that the light transmission density is defined by the international standard of cards (ISO/IEC 7810).

In addition, as the antenna device 1, the structure illustrated in FIG. 5C may be employed. The antenna device 1 illustrated in FIG. 5C includes a blackened layer 48 at an end of each electroconductive line of the conductor portion 18. The blackened layer 48 is provided in the first trench 44. The blackened layer 48 is provided so as to cover the end of the electroconductive line of the conductor portion 18 in the first trench 44 at the end 16a on the side opposite to the base material 13. The blackened layer 48 can contribute to improvement of visibility of the IC card 100 in which the antenna device 1 is incorporated. The blackened layer 48 may be formed by blackening the conductor portion 18, or a Ni layer (plating) may be stacked as an alternative to the blackening. In addition, the blackened layer 48 may be present on both the upper and lower sides by sandwiching the conductor portion 18 with a Ni layer like Ni layer/conductor portion/Ni layer.

Next, functions of the antenna device 1 will be described with reference to FIG. 4. A current CA flows through the coupling coil 53 (see FIG. 2) of the IC module 50. In FIG. 4, it is assumed that the current CA flows counterclockwise. At this time, a magnetic flux B (see FIG. 2) of the coupling coil 53 acts on the edge of the opening 20. Thus, a clockwise eddy current CB flows through the conductor pattern 14 near the edge of the opening 20. As described above, the conductor pattern 14 near the edge of the opening 20 functions as a coupling coil that is magnetically coupled to the coupling coil 53 of the IC module 50. Here, the conductor pattern 14 at the edge of the opening 20 on the negative side in the x-axis direction is divided by the slit 21 up to the edge 14c. Thus, the eddy current CB is divided by the slit 21, and currents CCa and CCb in the x-axis direction along the slit 21 flow. The current CCa flowing from the opening 20 toward the edge 14c side flows through the conductor pattern 14 at the edge of the slit 21 on the negative side in the y-axis direction. Thus, the counterclockwise current CD flows through the entire conductor pattern 14. In the conductor pattern 14 at the edge of the slit 21 on the positive side in the y-axis direction, the current CCb that returns from the edge 14c side to the opening 20 flows. As described above, the current in the same direction as the IC module 50 flows through the entire conductor pattern 14 of the antenna device 1, whereby the antenna device 1 can function as an antenna.

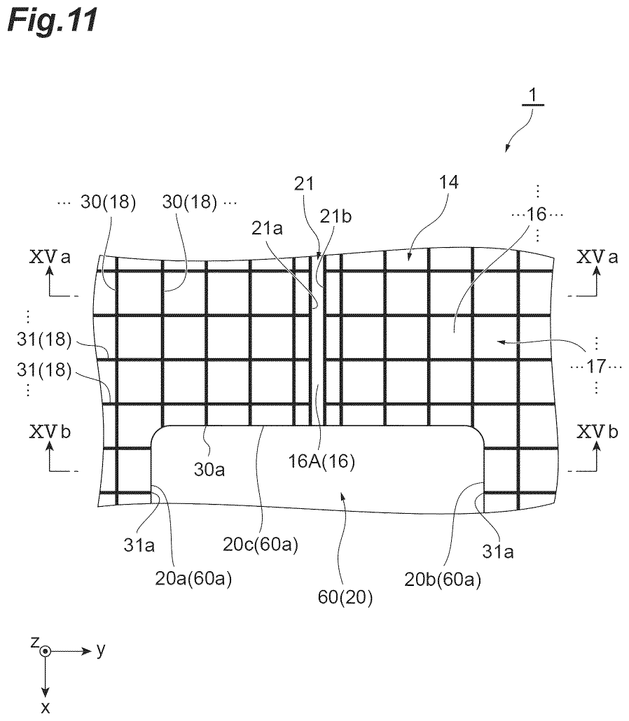

Next, the conductor pattern 14 will be described in detail with reference to FIG. 11. FIG. 11 is an enlarged view of the vicinity of a connection portion between the slit 21 and the opening 20. FIG. 11 illustrates an edge 21a on the negative side in the y-axis direction and an edge 21b on the positive side in the y-axis direction of the slit 21. Further, an edge 20a on the negative side in the y-axis direction, an edge 20b on the positive side in the y-axis direction, and an edge 20c on the negative side in the x-axis direction of the opening 20 are illustrated. The edges 20a, 20b, 21a, and 21b extend parallel to the x-axis direction. The edge 20c extends parallel to the y-axis direction.

As illustrated in FIG. 11, the conductor pattern 14 includes a plurality of first electroconductive lines 30 and a plurality of second electroconductive lines 31. The first electroconductive lines 30 are linear conductor portions 18 extending parallel to the x-axis direction (first direction). The plurality of first electroconductive lines 30 is arranged to be spaced apart from each other in the y-axis direction. The plurality of first electroconductive lines 30 is arranged to be spaced apart at a constant pitch. The second electroconductive lines 31 are linear conductor portions 18 extending parallel to the y-axis direction (second direction). The plurality of second electroconductive lines 31 is arranged to be spaced apart from each other in the x-axis direction. The plurality of second electroconductive lines 31 is arranged to be spaced apart at a constant pitch.

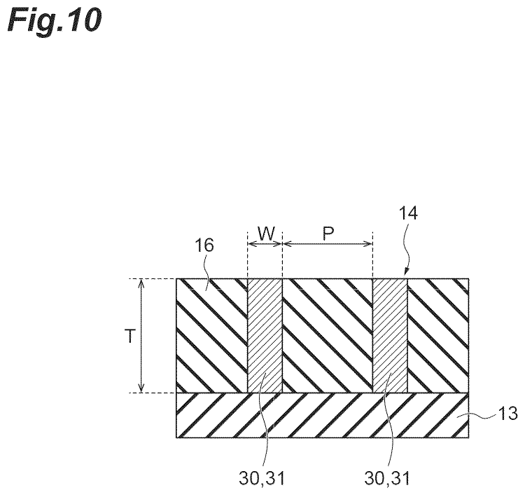

Each dimension of the electroconductive lines 30 and 31 is not particularly limited, but it is preferable that desired characteristics can be achieved even by a single mesh sheet including the resin layer 16 and the conductor pattern 14. For example, by adjusting each dimension of the electroconductive lines 30 and 31, it is preferable that the sheet resistance can be reduced while ensuring a desired aperture ratio in a single mesh sheet, and a desired antenna characteristic can be achieved. As illustrated in FIG. 10, the line width W of the electroconductive lines 30 and 31 is not particularly limited, but may be set to, for example, 1 to 3 μm. In addition, the pitch P of the electroconductive lines 30 and 31 is not particularly limited, and may be set to, for example, 25 to 100 μm. The first electroconductive lines 30 and the second electroconductive lines 31 have a line thickness larger than a line width. The line thickness T of the electroconductive lines 30 and 31 are dimensions in the z-axis direction. Thus, the cross-sectional shapes of the electroconductive lines 30 and 31 have shapes extending in the z-axis direction (see FIG. 3). The line thickness of the electroconductive lines 30 and 31 is not particularly limited, and may be set to, for example, 2 to 6 μm. Note that the ends of the electroconductive lines 30 and 31 in the z-axis direction may or may not coincide with the surface of the resin layer 16 in the z-axis direction. The aspect ratio of the electroconductive lines 30 and 31 may be set to, for example, 1 to 3 or the like. The aspect ratio of the electroconductive lines 30 and 31 is a ratio between a line thickness and a line width.

In the present embodiment, the first electroconductive lines 30 are substantially parallel to the x-axis direction which is the extending direction of the slit 21. The other second electroconductive lines 31 are substantially orthogonal to the x-axis direction which is the extending direction. Note that the first electroconductive lines 30 need not be parallel to the x-axis direction as long as they extend in the x-axis direction, and the second electroconductive lines 31 need not be parallel to the y-axis direction as long as they extend in the y-axis direction.

The normal first mesh portions 17 other than the vicinity of the slit 21 and the vicinity of the opening 20 will be described. Each first mesh portion 17 includes a pair of first electroconductive lines 30 adjacent to each other and a pair of second electroconductive lines 31 adjacent to each other. In the present embodiment, each first mesh portion 17 has a square shape. However, when the pitch of the first electroconductive lines 30 and the pitch of the second electroconductive lines 31 are different from each other, the first mesh portions 17 have a rectangular shape. In the first mesh portions 17, the resin layer 16 (FIGS. 5A to 5C) is disposed in an internal space surrounded by the four electroconductive lines 30 and 31. The pitch of the first mesh portions 17 in the y-axis direction is equal to the pitch of the first electroconductive lines 30. The pitch of the first mesh portions 17 in the x-axis direction is equal to the pitch of the second electroconductive lines 31. Note that, in the first mesh portions 17, the first electroconductive lines 30 and the second electroconductive lines 31 only need to intersect each other, and do not necessarily need to be orthogonal to each other. That is, the first mesh portions 17 in which the first electroconductive lines 30 and the second electroconductive lines 31 intersect in an inclined state may be employed.

The second electroconductive line 31 is provided at the positions of the edges 21a and 21b of the slit 21. The first electroconductive line 30 is disconnected at positions of the second electroconductive lines 31 and 31 constituting the edges 21a and 21b. Thus, the first electroconductive line 30 does not exist between the second electroconductive lines 31 and 31 constituting the edges 21a and 21b, and the other second electroconductive lines 31 do not exist either. The width of the slit 21 may be equal to or less than the pitch of the first mesh portions 17. Thus, the edges 21a and 21b are provided between the second electroconductive lines 31 and 31 for one pitch. However, the width of the slit 21 may be larger than the pitch of the first mesh portions 17 (see, for example, FIG. 4). In addition, the second electroconductive lines 31 and 31 need not be provided at the positions of the edges 21a and 21b, or may be provided at only one of the positions.

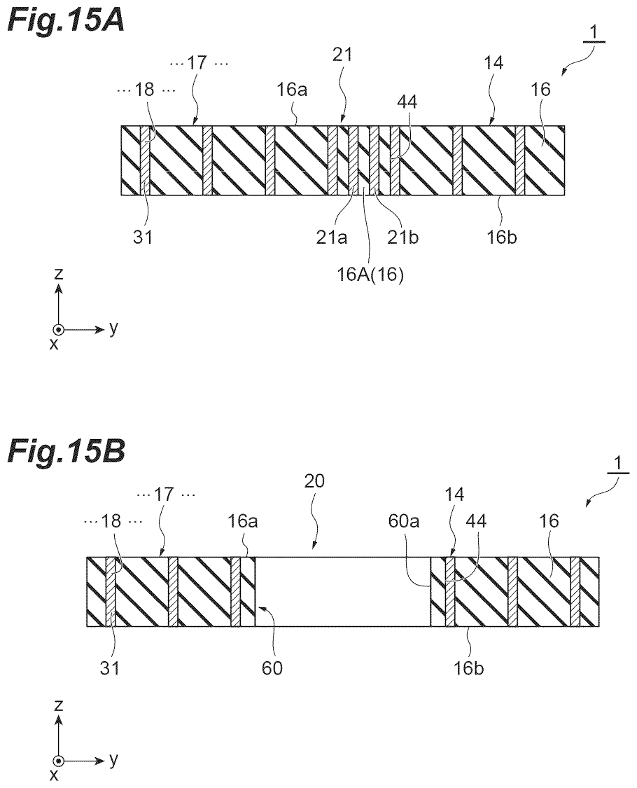

The resin layer 16 is disposed in the slit 21. Such a resin layer 16 may be referred to as a slit-filling resin layer 16A. The slit-filling resin layer 16A extends from the edge 20c of the opening 20 to the edge 14c of the conductor pattern 14 (see FIG. 4) together with the slit 21 between the second electroconductive lines 31 and 31 constituting the edges 21a and 21b. FIG. 15A is a cross-sectional view taken along line XVa-XVa of FIG. 11. As illustrated in FIG. 15A, the slit-filling resin layer 16A extends from one end 16a to the other end 16b in the thickness direction (z-axis direction), as with the other portions of the resin layer 16.

FIG. 15B is a cross-sectional view taken along line XVb-XVb in FIG. 11. As illustrated in FIG. 15B, the opening 20 has a through hole 60 penetrating from one end 16a to the other end 16b in the thickness direction (z-axis direction) of the resin layer 16. The resin layer 16 is not disposed in the through hole 60. Therefore, as illustrated in FIG. 3, a protruding shape of the IC module 50 can be disposed. As illustrated in FIG. 11, the edges 20a, 20b, and 20c of the opening 20 are configured by an inner peripheral surface 60a of the through hole 60.

The electroconductive lines 30 and 31 extending toward the opening 20 are disconnected at the position of the opening 20. Thus, the electroconductive lines 30 and 31 (that is, the first mesh portions 17) are not formed in the opening 20. For example, when the above-described configurations of FIGS. 3 and 9 are employed, a tip of at least one of the electroconductive line 30 or 31 extending toward the opening 20 reaches the inner peripheral surface 60a of the through hole 60. Specifically, a tip 31a of the second electroconductive line 31 extending from the negative side toward the positive side in the y-axis direction toward the opening 20 reaches the edge 20a. A tip 31a of the second electroconductive line 31 extending from the positive side toward the negative side in the y-axis direction toward the opening 20 reaches the edge 20b. A tip 30a of the first electroconductive line 30 extending from the negative side toward the positive side in the x-axis direction toward the opening 20 reaches the edge 20c. Thus, the electroconductive lines 30 and 31 are exposed from the resin layer 16 from the inner peripheral surface 60a.

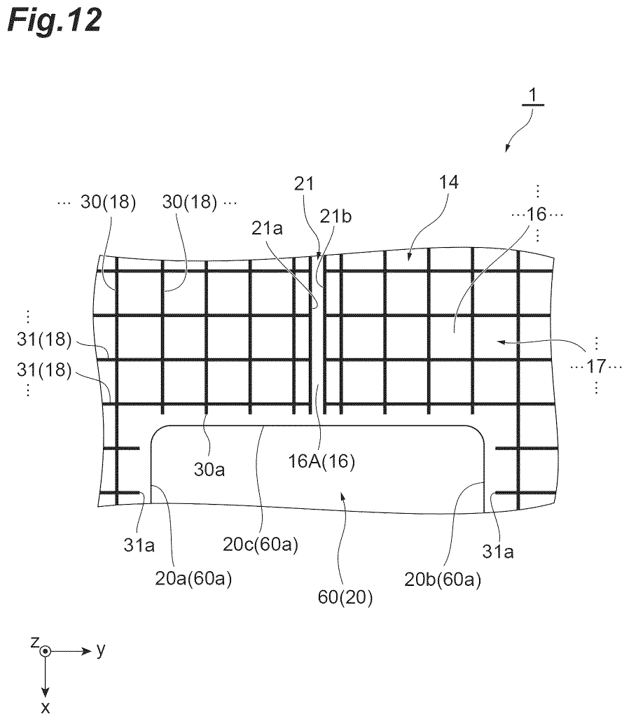

Alternatively, in a case where the above-described configurations of FIGS. 6 to 8 are employed, the configuration illustrated in FIG. 12 may be employed. In FIG. 12, a tip of at least one of the electroconductive line 30 or 31 extending toward the opening 20 is separated from the inner peripheral surface 60a of the through hole 60. Specifically, the tip 31a of the second electroconductive line 31 extending from the negative side toward the positive side in the y-axis direction toward the opening 20 is separated from the edge 20a toward the negative side in the y-axis direction. The tip 31a of the second electroconductive line 31 extending from the positive side toward the negative side in the y-axis direction toward the opening 20 is separated from the edge 20b toward the positive side in the y-axis direction. The tip 30a of the first electroconductive line 30 extending from the negative side toward the positive side in the x-axis direction toward the opening 20 is separated from the edge 20c toward the negative side in the x-axis direction. Thus, the electroconductive lines 30 and 31 are not exposed, and the inner peripheral surface 60a becomes a surface configured only by the resin layer 16.

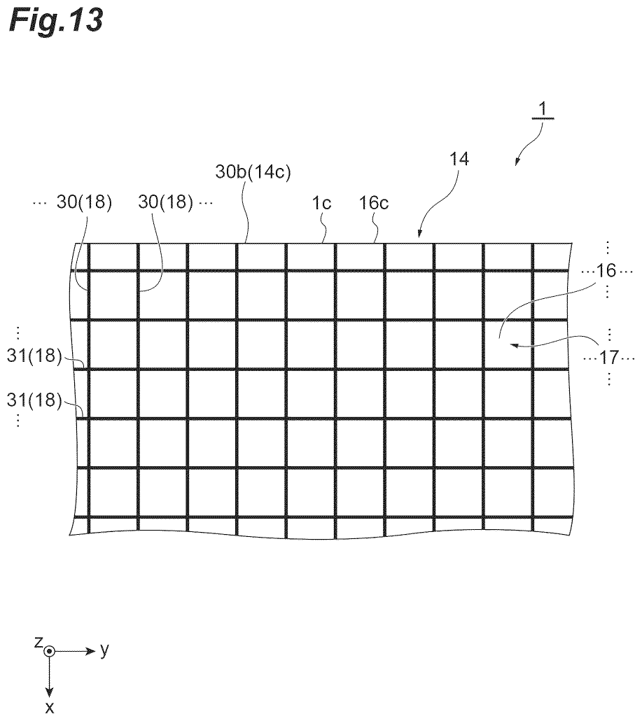

Next, the configuration near the edge of the conductor pattern 14 will be described in more detail with reference to FIG. 4. For example, in a case where the above-described configurations of FIGS. 3 and 9 are employed, the edges 14c, 14d, 14e, and 14f of the conductor pattern 14 extend so as to coincide with the edges 1c, 1d, 1e, and 1f of the antenna device 1. Thus, tips of the electroconductive lines 30 and 31 reaching the respective edges 14c, 14d, 14e, and 14f of the conductor pattern 14 are exposed from the outer peripheral surface of the resin layer 16. Specifically, as illustrated in FIG. 13, the electroconductive line 30 extending from the positive side to the negative side in the X-axis direction reaches the edge 1c (an outer peripheral surface 16c of the resin layer 16) of the antenna device 1. Thus, a tip 30b of the electroconductive line 30 is exposed from the outer peripheral surface 16c of the resin layer 16. Note that, in the other outer peripheral surface 16c of the resin layer 16, the tips of the electroconductive lines 30 and 31 are similarly exposed.

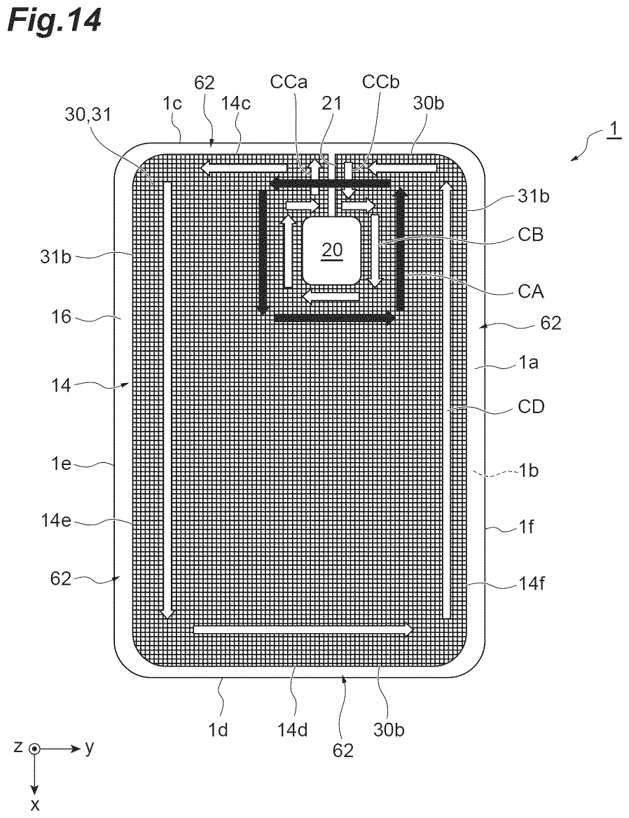

Alternatively, in a case where the above-described configurations of FIGS. 6 to 8 are employed, the configuration illustrated in FIG. 14 may be employed. In FIG. 14, the edges 14c, 14d, 14e, and 14f of the conductor pattern 14 extend in parallel along the edges 1c, 1d, 1e, and 1f of the antenna device 1, and are arranged on the inner peripheral side from the edges 1c, 1d, 1e, and 1f. Thus, the resin layer 16 has an outer peripheral region 62 extending on the outer peripheral side of the tips 30b and 31b of the electroconductive lines 30 and 31 reaching the edges 14c, 14d, 14e, and 14f of the conductor pattern 14. The outer peripheral region 62 is formed on each of the four sides along the four edges 1c, 1d, 1e, and 1f of the antenna device 1. In the example illustrated in FIG. 4, no electroconductive line is provided in the outer peripheral region 62, and the outer peripheral region 62 has a configuration in which the resin layer 16 spreads.

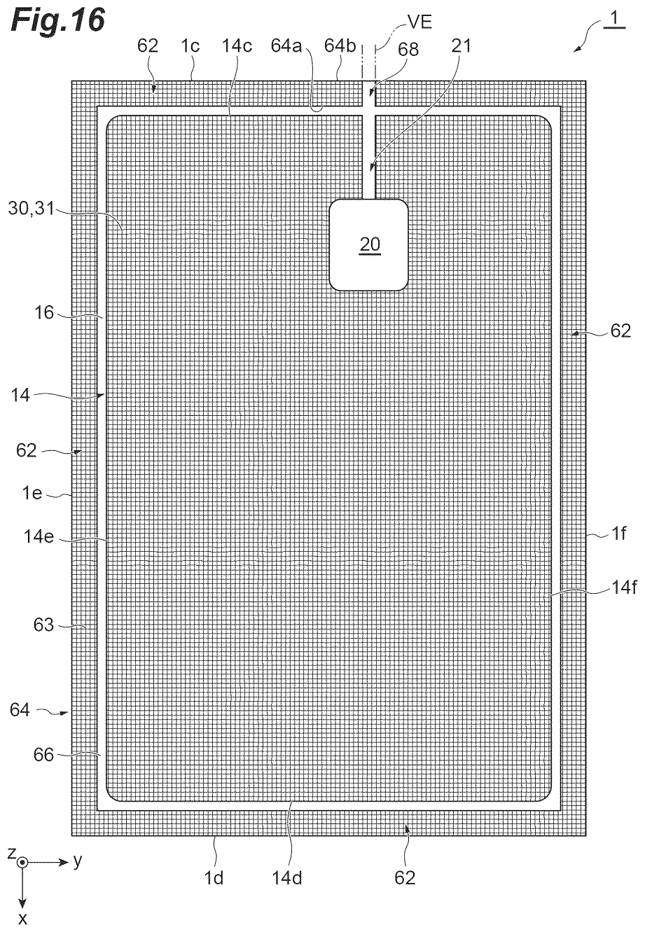

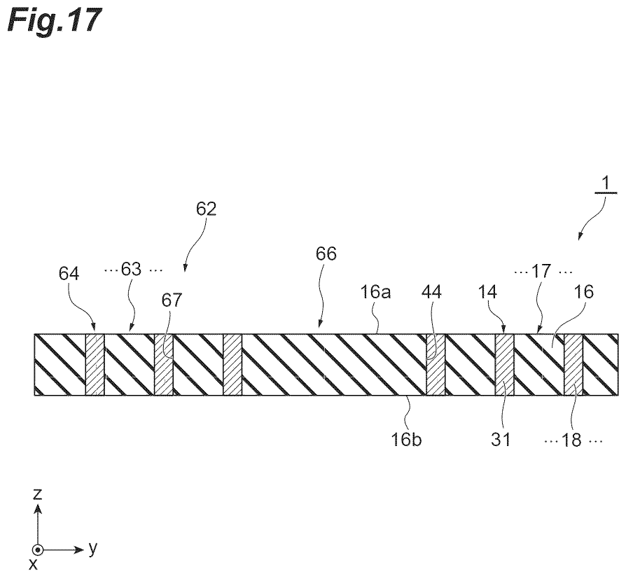

In addition, a configuration illustrated in FIG. 16 may be employed. As illustrated in FIG. 16, the outer peripheral region 62 may have an outer peripheral conductor pattern 64 having a plurality of second mesh portions 63. The outer peripheral conductor pattern 64 is disposed with a gap 66 from the conductor pattern 14. Such an outer peripheral conductor pattern 64 and a gap 66 are provided for four outer peripheral regions 62. FIG. 17 is a cross-sectional view of the vicinity of the gap 66. As illustrated in FIG. 17, the resin layer 16 includes a mesh-shaped second trench 67 in the outer peripheral region 62. The resin layer 16 has the outer peripheral conductor pattern 64 having a plurality of second mesh portions 63 disposed in the second trench 67.

As illustrated in FIG. 16, the outer peripheral conductor pattern 64 has a slit 68 in which the second mesh portions 63 are not formed from an inner edge 64a to an outer edge 64b. A virtual region VE in which the slit 21 of the conductor pattern 14 is virtually extended toward the outer peripheral region 62 is set. At this time, the slit 68 of the outer peripheral conductor pattern 64 is provided at a position overlapping the virtual region VE. Therefore, the slit 21 and the slit 68 are configured like a single slit extending from the opening 20. The width of the slit 68 may be the same as the width of the slit 21. Further, the resin layer 16 is also disposed in the slit 68. However, the position of the slit 68 is not particularly limited, and may be formed at a position not overlapping with the virtual region VE of the slit 21.

Note that the edges 14c, 14d, 14e, and 14f may be arranged without gaps from the edges 1c, 1d, 1e, and 1f. In this case, the outer peripheral region 62 is not provided.

Next, functions and effects of the antenna device 1 and the IC card 100 according to the present embodiment will be described.

In the antenna device 1 according to the present embodiment, the resin layer 16 includes the first trenches 44 extending in the X-axis direction (first direction) and the Y-axis direction (second direction). Further, the conductor pattern 14 is disposed in the first trench 44 of the resin layer 16, includes the electroconductive lines 30 and 31, and has a plurality of first mesh portions 17. Thus, the conductor pattern 14 is sufficiently supported in the first trench 44 of the resin layer 16. Here, the conductor pattern 14 includes the opening 20 (first region) and the slit 21 (second region) in which the first mesh portions 17 are not formed. The opening 20 has the through hole 60 penetrating from one end 16a to the other end 16b in the thickness direction of the resin layer 16. Thus, the opening 20 can absorb the protruding shape (protruding shape by the protective resin 55) of the IC module 50 in the through hole 60. On the other hand, the slit 21 extends from the opening 20 to the edge 14c of the conductor pattern 14. Further, the width of the slit 21 is smaller than the width of the opening 20. Thus, when the slit 21 is a penetrating portion, the conductor patterns 14 separated by the slit 21 are in contact with each other near the slit 21 to form a loop, which is likely to cause a problem of failing to function as an antenna. On the other hand, in the present embodiment, the resin layer 16 is disposed in the slit 21. Thus, the resin layer 16 can support the slit 21 having a narrow width. Thus, it is possible to suppress contact between the conductor patterns 14 near the slit 21. As described above, it is possible to reduce the thickness while suppressing contact between the mesh-shaped conductor patterns.

The tip 30a or 30b of at least one of the first electroconductive line 30 or the second electroconductive line 31 extending toward the opening 20 may be separated from the inner peripheral surface 60a of the through hole 60. In this case, the electroconductive lines 30 and 31 are not exposed on the inner peripheral surface 60a of the through hole 60. Thus, deterioration of the conductor pattern 14 can be suppressed.

The width of the slit 21 may be equal to or less than the pitch of the first mesh portions 17. In this case, by reducing the width of the slit 21, which is a region where the first mesh portions 17 are not formed, as much as possible, the invisibility of the conductor pattern 14 is improved.

The resin layer 16 may have the outer peripheral region 62 extending on the outer peripheral side of the tips 30b and 31b of the first electroconductive lines 30 and the second electroconductive lines 31 reaching the edges of the conductor pattern 14. In this case, the outer peripheral region 62 can ensure insulation with respect to the conductor pattern 14.

The resin layer 16 may have the mesh-shaped second trench 67 in the outer peripheral region 62 and have the outer peripheral conductor pattern 64 having the plurality of second mesh portions 63 disposed in the second trench 67, and the outer peripheral conductor pattern 64 may be disposed with the gap 66 from the conductor pattern 14. In this case, the outer peripheral conductor pattern 64 functions as a dummy mesh for the outer peripheral edge of the conductor pattern 14, thereby improving the non-visibility of the conductor pattern 14.

The outer peripheral conductor pattern 64 may have the slit 68 in which the second mesh portions 63 are not formed from the inner edge 64a to the outer edge 64b. In this case, the slit 68 prevents the outer peripheral conductor pattern 64, which is a dummy mesh, from forming a loop, so that deterioration of characteristics due to a diamagnetic field accompanying the formation of the loop can be suppressed.

The slit 68 of the outer peripheral conductor pattern 64 may overlap with a virtual region VE obtained by extending the slit 21 of the conductor pattern 14 toward the side of the outer peripheral region 62. In this case, the invisibility of the conductor patterns 14 and 64 can be improved by concentrating the formation positions of the slits 21 and 68.

The tip of at least one of the first electroconductive line 30 or the second electroconductive line 31 extending toward the opening 20 may be exposed from the inner peripheral surface 20e of the through hole. In this case, the tips of the electroconductive lines 30 and 31 can be formed by, for example, punching or the like.

The tips of the first electroconductive line 30 and the second electroconductive line 31 reaching the edges 14c, 14d, 14e, 14f of the conductor pattern 14 may be exposed from the outer peripheral surface 16c of the resin layer 16. In this case, the tips of the electroconductive lines 30 and 31 can be formed by, for example, punching or the like.

The IC card 100 according to the present embodiment includes the card main body 80 including the first card base material 2 and the second card base material 3, the antenna device 1 described above disposed between the first card base material 2 and the second card base material 3, and the IC module 50 disposed in the IC mounting opening 4 of the first card base material 2.

With the IC card 100, it is possible to obtain the same effects as those of the antenna device 1 described above.

The conductor pattern 14 and the resin layer 16 may be disposed on the second card base material 3. In this case, damage due to machine cutting can be alleviated by the second card base material 3 at the time of outer shape cutting processing and cavity processing (processing of a hole for filling the IC module 50) of the IC card 100 after card stacking. Therefore, the mesh-shaped conductor pattern 14 can be protected.

The conductor pattern 14 and the resin layer 16 may be disposed on the base material 13, and the second card base material 3, the conductor pattern 14, the base material 13, and the first card base material 2 may be stacked in this order. In this case, the base material can ensure insulation between the conductor pattern 14 and the IC module 50.

The infrared ray shielding layer 15 that shields infrared rays may be disposed between the first card base material 2 and the second card base material 3. In this case, the presence of the IC card 100 can be detected in an application for detecting the presence of the card by attenuation of light between a light source and a sensor.

The present disclosure is not limited to the above-described embodiment.

For example, the position and arrangement of each component of the IC card 100 and each component of the antenna device 1 described above are merely examples, and can be appropriately changed without departing from the gist of the present disclosure, and some components may be omitted.

For example, the resin layer 16 may be formed on the front and back surfaces of the base material 13, the first electroconductive lines 30 may be arranged in the first trench 44 of the resin layer 16 on the front side, and the second electroconductive lines 31 may be arranged in the first trench 44 of the resin layer 16 on the back side, so that the front and back surfaces form a mesh shape.

[Aspect 1] An antenna device including:
a resin layer having a first trench extending in a first direction and a second direction intersecting the first direction; and
a conductor pattern disposed in the first trench of the resin layer, including a plurality of first electroconductive lines extending in the first direction and a plurality of second electroconductive lines extending in the second direction, and including a plurality of first mesh portions, in which
the conductor pattern includes a first region and a second region in which the first mesh portion is not formed,
the second region extends from the first region to an edge of the conductor pattern,
a width of the second region is smaller than a width of the first region,
the first region has a through hole penetrating from one end to another end in a thickness direction of the resin layer, and
the resin layer is disposed in the second region.

[Aspect 2] The antenna device according to aspect 1, in which a tip of at least one of the first electroconductive line or the second electroconductive line extending toward the first region is separated from an inner peripheral surface of the through hole.

[Aspect 3] The antenna device according to aspect 1 or 2, in which a width of the second region is equal to or less than a pitch of the first mesh portion.

[Aspect 4] The antenna device according to any one of aspects 1 to 3, in which the resin layer has an outer peripheral region extending on an outer peripheral side of tips of the first electroconductive line and the second electroconductive line reaching an edge of the conductor pattern.

[Aspect 5] The antenna device according to aspect 4, in which
the resin layer has a mesh-shaped second trench in the outer peripheral region, and has an outer peripheral conductor pattern having a plurality of second mesh portions disposed in the second trench, and
the outer peripheral conductor pattern is disposed with a gap from the conductor pattern.

[Aspect 6] The antenna device according to aspect 5, in which the outer peripheral conductor pattern has a slit in which the second mesh portions are not formed from an inner edge to an outer edge.

[Aspect 7] The antenna device according to aspect 6, in which the slit of the outer peripheral conductor pattern overlaps with a virtual region obtained by extending the second region of the conductor pattern toward a side of the outer peripheral region.

[Aspect 8] The antenna device according to any one of aspects 1 to 7, in which a tip of at least one of the first electroconductive line or the second electroconductive line extending toward the first region is exposed from an inner peripheral surface of the through hole.

[Aspect 9] The antenna device according to aspect 1, in which tips of the first electroconductive line and the second electroconductive line reaching an edge of the conductor pattern are exposed from an outer peripheral surface of the resin layer.

[Aspect 10] An IC card including:
a card main body including a first card base material and a second card base material;
the antenna device according to any one of aspects 1 to 9 disposed between the first card base material and the second card base material; and
an IC module disposed in an IC mounting opening of the first card base material.

[Aspect 11] The IC card according to aspect 10, in which the conductor pattern and the resin layer are disposed on the second card base material.

[Aspect 12] The IC card according to aspect 11, in which
the conductor pattern and the resin layer are disposed on a base material, and
the second card base material, the conductor pattern, the base material, and the first card base material are stacked in an order of the second card base material, the conductor pattern, the base material, and the first card base material.

[Aspect 13] The IC card according to any one of aspects 10 to 12, in which an infrared ray shielding layer that shields infrared rays is disposed between the first card base material and the second card base material.

### REFERENCE SIGNS LIST

1 Antenna device
2 First card base material
3 Second card base material
4 IC mounting opening
13 Base material
14 Conductor pattern
15 Infrared ray shielding layer
16 Resin layer
17 First mesh portion
20 Opening (first region)
21 Slit (second region)
30 First electroconductive line
31 Second electroconductive line
44 First trench
50 IC module
62 Outer peripheral side region
63 Second mesh portion
67 Second trench
80 Card main body
100 IC card

What is claimed is:

1. An antenna device comprising:
a resin layer having a first trench extending in a first direction and a second direction intersecting the first direction; and
a conductor pattern disposed in the first trench of the resin layer, including a plurality of first electroconductive lines extending in the first direction and a plurality of second electroconductive lines extending in the second direction, and including a plurality of first mesh portions, wherein
the conductor pattern includes a first region and a second region in which the first mesh portion is not formed,
the second region extends from the first region to an edge of the conductor pattern,
a width of the second region is smaller than a width of the first region,
the first region has a through hole penetrating from one end to another end in a thickness direction of the resin layer, and
the resin layer is disposed in the second region.

2. The antenna device according to claim 1, wherein a tip of at least one of the first electroconductive line or the second electroconductive line extending toward the first region is separated from an inner peripheral surface of the through hole.

3. The antenna device according to claim 1, wherein a width of the second region is equal to or less than a pitch of the first mesh portion.

4. The antenna device according to claim 1, wherein the resin layer has an outer peripheral region extending on an outer peripheral side of tips of the first electroconductive line and the second electroconductive line reaching an edge of the conductor pattern.

5. The antenna device according to claim 4, wherein
the resin layer has a mesh-shaped second trench in the outer peripheral region, and has an outer peripheral conductor pattern having a plurality of second mesh portions disposed in the second trench, and
the outer peripheral conductor pattern is disposed with a gap from the conductor pattern.

6. The antenna device according to claim 5, wherein the outer peripheral conductor pattern has a slit in which the second mesh portions are not formed from an inner edge to an outer edge.

7. The antenna device according to claim 6, wherein the slit of the outer peripheral conductor pattern overlaps with a virtual region obtained by extending the second region of the conductor pattern toward a side of the outer peripheral region.

8. The antenna device according to claim 1, wherein a tip of at least one of the first electroconductive line or the second electroconductive line extending toward the first region is exposed from an inner peripheral surface of the through hole.

9. The antenna device according to claim 1, wherein tips of the first electroconductive line and the second electroconductive line reaching an edge of the conductor pattern are exposed from an outer peripheral surface of the resin layer.

10. An IC card comprising:
a card main body including a first card base material and a second card base material;
the antenna device according to claim 1 disposed between the first card base material and the second card base material; and
an IC module disposed in an IC mounting opening of the first card base material.

11. The IC card according to claim 10, wherein the conductor pattern and the resin layer are disposed on the second card base material.

12. The IC card according to claim 11, wherein
the conductor pattern and the resin layer are disposed on a base material, and
the second card base material, the conductor pattern, the base material, and the first card base material are stacked in an order of the second card base material, the conductor pattern, the base material, and the first card base material.

13. The IC card according to claim 10, wherein an infrared ray shielding layer that shields infrared rays is disposed between the first card base material and the second card base material.
